(19) United States
(12) Patent Application Publication
(10) Pub. No.: US 2020/0083594 A1
(43) Pub. Date: Mar. 12, 2020

(54) ANTENNA ASSEMBLY

(71) Applicants: Esa MÄÄTTÄ, Kista (SE); HUAWEI TECHNOLOGIES CO., LTD., Shenzhen (CN)

(72) Inventors: Esa MAATTA, Kista (SE); Jouni PENNANEN, Kista (SE); Ilkka NIEMELA, Helsinki (FI); Ilkka SAARINEN, Helsinki (FI); Ismo MANELIUS, Helsinki (FI); David POWNEY, Helsinki (FI); Guoping LUO, Helsinki (FI); Jari LAMMINPARRAS, Helsinki (FI); Mikko KYLKILAHTI, Helsinki (FI); Kyosti KATAJA, Helsinki (FI)

(73) Assignee: HUAWEI TECHNOLOGIES CO., LTD., Shenzhen (CN)

(21) Appl. No.: 16/609,520

(22) PCT Filed: May 23, 2017
(86) PCT No.: PCT/EP2017/062423

§ 371 Date: Oct. 30, 2019

(51) Int. Cl. H01Q 1/24; H01Q 1/38; H01Q 21/00

(52) U.S. Cl. CPC H01Q 1/243; H01Q 21/0025; H01Q 1/38

(57) ABSTRACT

An antenna assembly including a support and at least one conductive layer on the support having an antenna radiator patterned therein. The antenna assembly further includes a first conductive pad on the support, and the first conductive pad is electrically coupled to the antenna radiator. Additionally, the antenna assembly includes a radio frequency (RF) transmission line structure attached to the support, and the RF transmission line structure includes a signal line for transmitting an RF signal to or from the antenna radiator, the signal line being capacitively coupled to the first conductive pad.

### CROSS-REFERENCE TO RELATED APPLICATIONS

This application is a National Stage of International Patent Application No. PCT/EP2017/062423, filed on May 23, 2017, which is hereby incorporated by reference in its entirety.

### FIELD

The present application relates to the field of wireless communications, and more particularly to an antenna assembly.

### BACKGROUND

In wireless communications, an antenna is a critical component. The antenna is responsible for remotely transmitting and receiving the radio waves used in communications. To transfer a signal between an antenna and a corresponding transmitter, receiver or a transmitter-receiver, the impedance of the antenna may be specifically matched to the external circuit so that power transfer between them may be improved or the signal reflection may be reduced.

Traditionally, it has been very common to create a matching circuit using surface mount components which may be placed, for example, next to an antenna feeding point on printed circuit boards (PCBs). However, such components are bulky and may additionally have restrictive requirements with respect to how and on what type of surface they may be attached.

As more and more different types of devices become equipped with antennas, new types of antenna arrangements are required so that the antennas may be both adapted to various applications and be manufactured in a cost-efficient manner, for example in automated mass production. In addition, the miniaturization of devices also sets requirements for the components, such as antennas used therein as the components in the devices are typically packed very tightly.

### SUMMARY

This summary introduces various exemplary embodiments that are elaborated upon below, and is not intended to be used to limit the scope of the claimed subject matter.

It is an object of exemplary embodiments to provide an antenna assembly. Further implementation forms are apparent from the description and the figures.

According to a first embodiment an antenna assembly is provided. The antenna assembly includes a support and at least one conductive layer on the support having an antenna radiator patterned therein. The antenna assembly further includes a first conductive pad on the support, and the first conductive pad is electrically coupled to the antenna radiator. Additionally, the antenna assembly includes a radio frequency (RF) transmission line structure attached to the support, and the RF transmission line structure includes a signal line for transmitting an RF signal to or from the antenna radiator, the signal line being capacitively coupled to the first conductive pad. By patterning the antenna on a conductive layer on the support, an adjustable conductive circuit may be created having thickness smaller than what would result from using bulky components. Such a circuit may also withstand bending. The assembly allows, in the same manufacturing phase, for depositing one or more antenna patterns on the same support together with any features and other independent circuits and positioning one or more contact pads to provide feeding points where external signal feeds may subsequently be connected. By attaching an external transmission line to the support through capacitive coupling, a capacitive element in antenna matching may be formed without using any dedicated components, such as surface mount components. The separate installation of the feed line after the antenna plane has first been fabricated provide for accurate positioning of the antenna components. For example, this may be exploited in an arrangement where more than one circuit having antenna radiators are fabricated on the same support.

In a further implementation of the antenna assembly according to the first embodiment, the RF transmission line structure is a printed circuit board (PCB). By using PCB technology, transmission line may be adapted to the particular requirements of the assembly and its specific application.

In a further implementation of the antenna assembly according to the first embodiment, the RF transmission line structure is a flexible printed circuit board (FPC). This allows adaptable placement of the antenna assembly so that it may be used in dynamic and high-flex applications, where the assembly is required to flex during its normal use. Additionally, the flexibility may also relax space constraints for electrical connections.

In a further implementation of the antenna assembly according to the first embodiment, the RF transmission line structure is a coaxial or a planar transmission line. These transmission line structures provide improved signal transmission characteristics and reduced signal loss compared to many of their alternatives. Planar transmissions lines, for example, may be fabricated with a low profile to meet potential space constraints.

In a further implementation of the antenna assembly according to the first embodiment, the support is of dielectric material. Consequently, the support may act as an insulator to allow the placement of several electrical components within a constrained space.

In a further implementation of the antenna assembly according to the first embodiment, the transmission line structure is attached to the support with adhesive, the adhesive forming a layer of dielectric material through which the signal line is capacitively coupled to the first conductive pad. This allows the layer of adhesive to serve a dual purpose in both attaching the transmission line and providing the dielectric required for a capacitive connection. This reduces the number of required manufacturing steps. Using adhesive as manner for attachment prevents mechanical damage on the contact point(s), for example when the feeding point or the whole support is made of a thin film.

In a further implementation of the antenna assembly according to the first embodiment, the RF transmission line structure is attached to the support with conductive adhesive or solder. By using a layer of conductive adhesive or solder to attach the transmission line, a conductive path is formed between the transmission line and the support. This path may be used, for example, for grounding. Furthermore, using adhesive as manner for attachment prevents mechanical damages on the contact point(s), for example when the feeding point or the whole support is made of a thin film.

In a further implementation of the antenna assembly according to the first embodiment, the antenna assembly includes one or more antenna matching components patterned in the at least one conductive layer and integrated to the antenna radiator. This allows all the antenna matching components to be integrated in the antenna assembly so that no additional components, for example surface mount components, are required. Consequently, the antenna assembly can be made very thin and its response to bending may be improved. As the capacitive connection between the RF transmission line and the first conductive pad already forms one part of the matching circuit, the complete matching circuit is then formed together with the patterned antenna matching components and the transmission line connection. By patterning the additional antenna matching components instead of using heating methods, excess heating of the support can be avoided which, in turn, allows using support materials susceptible to heat such as thin films or transparent supports.

In a further implementation of the antenna assembly according to the first embodiment, the one or more antenna matching components include any combination of resistive, capacitive and inductive components. Using a selection of patterned resistive, capacitive and inductive components, a matching circuit having desired impedance may be formed including resistance, reactance, capacitive reactance and inductive reactance. The desired impedance may correspond to impedance which minimizes the loss in signal transfer to and from the antenna in the operating frequencies of the antenna. While the coupling between the RF transmission line structure and the first conductive pad may remove the requirement for additional capacitive elements in the antenna pattern, the application-specific requirement may also make it beneficial to divide the capacitive reactance of the circuit into that produced by the attachment of the transmission line and that produced by one or more patterned capacitive elements on the support.

In a further implementation of the antenna assembly according to the first embodiment, the antenna matching components have thickness of 100 μm or less. As the patterning technologies currently available allow fabricating features smaller than 100 μm, using this small feature size for antenna matching components allows conservation of space and improvement in the bending properties of the antenna assembly.

In a further implementation of the antenna assembly according to the first embodiment, the RF transmission line structure includes a second conductive pad connected to an end of the signal line, where the second conductive pad is suitable for capacitively coupling the signal line to the first conductive pad. While the signal line itself may be coupled capacitively to another conducting element across a dielectric layer, using a conductive pad allows adjusting the properties such as the dimensions of the connection interface and, consequently, the capacitance of the connection. For example, the conductive pad may be formed as a capacitor plate in two dimensions, the area of which becomes directly proportional to the capacitance in case the first conductive pad comprises an equally sized and aligned capacitor plate.

According to a second embodiment, a method is provided. The method includes patterning an antenna radiator into at least one conductive layer on a support, forming a first conductive pad on the support and electrically coupling the first conductive pad to the antenna radiator. The method further includes attaching an RF transmission line structure including a signal line to the support and coupling the signal line to the first conductive pad through a capacitive connection. By patterning the antenna on a conductive layer on the support, an adjustable conductive circuit may be formed having thickness smaller than what would result from using bulky components. Such a circuit may also withstand bending. The assembly allows, in the same manufacturing phase, depositing one or more antenna patterns on the same support together with any features and other independent circuits and positioning one or more contact pads to provide feeding points where external signal feeds may subsequently be connected. By attaching an external transmission line to the support through capacitive coupling, a capacitive element required in antenna matching may be formed without using any dedicated components such as surface mount components. The separate installation of the feed line after the antenna plane has first been fabricated enables accurate positioning for the antenna components. For example, this may be exploited in an arrangement where more than one circuits including antenna radiators are fabricated on the same support.

In a further implementation of the method according to the second embodiment, the RF transmission line structure is a PCB. By using PCB technology, a transmission line may be adapted to the particular requirements of the assembly and its specific application.

In a further implementation of the method according to the second embodiment, the RF transmission line structure is a flexible printed circuit board. This allows adaptable placement of the antenna assembly so that it may be used in dynamic and high-flex applications, where the assembly is required to flex during its normal use. Additionally, the flexibility may also relax space constraints for electrical connections.

In a further implementation of the method according to the second embodiment, the method further includes attaching the RF transmission line structure to the support with adhesive, and the adhesive forms a layer of dielectric material through which the signal line is capacitively coupled to the first conductive pad. This allows the layer of adhesive to serve a dual purpose in both attaching the transmission line and providing the dielectric required for a capacitive connection. This reduces the number of required manufacturing steps. Using adhesive as manner for attachment prevents mechanical damages on the contact point, for example when the feeding point or the whole support is made of a thin film.

In a further implementation of the method according to the second embodiment, the method further includes attaching the RF transmission line structure to the support with conductive adhesive or solder. By using a layer of conductive adhesive or solder to attach the transmission line, a conductive path is formed between the transmission line and the support. This path may be used, for example, for grounding. Furthermore, using adhesive as manner for attachment prevents mechanical damages on the contact point(s), for example when the feeding point or the whole support is made of a thin film.

In a further implementation of the method according to the second embodiment, the method further includes patterning one or more antenna matching components in the at least one conductive layer, wherein the antenna matching components are integrated to the antenna radiator. This allows all the antenna matching components to be integrated in the antenna assembly so that no additional components, for example surface mount components, are required. Consequently, the antenna assembly can be made very thin and its response to bending may be improved. As the capacitive connection between the RF transmission line and the first conductive pad already forms one part of the matching circuit, the complete matching circuit is then formed together with the patterned antenna matching components and the transmission line connection. By patterning the additional antenna matching components instead of using heating methods, excess heating of the support can be avoided which, in turn, allows using support materials susceptible to heat such as thin films or transparent supports.

In a further implementation of the method according to the second embodiment, the method further includes forming a second conductive pad for capacitively coupling the signal line to the first conductive pad and connecting the second conductive pad to an end of the signal line in the RF transmission line structure.

According to a third embodiment, an apparatus is provided. The apparatus includes the antenna assembly according to the first embodiments or any of further implementation forms. The apparatus may be any kind of apparatus utilizing antennas for wireless communication.

Many of the attendant features will be more readily appreciated as they become better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 illustrates a schematic representation of an antenna assembly.

FIG. 2 illustrates another schematic representation of an antenna assembly.

FIG. 3a illustrates an exploded view of a schematic representation of an RF transmission line structure.

FIG. 3b illustrates a schematic representation of an RF transmission line structure.

FIG. 3c illustrates a cross sectional view of a schematic representation of an RF transmission line structure.

FIG. 3d illustrates another cross sectional view of a schematic representation of an RF transmission line structure.

FIG. 4a illustrates a cross sectional view of a schematic representation of an RF transmission line structure in an antenna assembly.

FIG. 4b illustrates a cross sectional view of a schematic representation of another RF transmission line structure in an antenna assembly.

FIG. 5a illustrates a cross sectional view of a schematic representation of yet another RF transmission line structure in an antenna assembly.

FIG. 5b illustrates a cross sectional view of a schematic representation of another RF transmission line structure in an antenna assembly.

FIG. 6 illustrates a flowchart showing a method of forming an antenna assembly.

Like references are used to designate like parts in the accompanying drawings.

### DETAILED DESCRIPTION

The detailed description provided below in connection with the appended drawings is intended as a description of the embodiments and is not intended to represent the only forms in which the embodiment may be constructed or utilized. However, the same or equivalent functions and structures may be accomplished by different embodiments.

According to an embodiment, a solution is provided where an antenna assembly may be constructed on a support without using bulky surface mount components. The assembly can be made very thin so that it may be used in applications requiring the assembly to bend without breaking. Furthermore, the antenna assembly allows the support to be used for one or more circuits patterned therein in the same manufacturing phase so that one or more signal feeding points may be prepared at the same time and, subsequently, one or more signal feeds such as RF transmission lines may be coupled to the support. When a signal feed is coupled to the support and the antenna pattern therein through a capacitive connection, the coupling produces capacitive impedance so that the coupling itself may function as an antenna matching element.

According to an embodiment, an antenna assembly is provided where an antenna assembly may be constructed without using excessive amounts of heat, for example in soldering surface mount components to the support. This allows for the use of thin support materials such as soft plastic films. Also transparent or decorative supports may be used as possible visual defects resulting from heating may be eliminated.

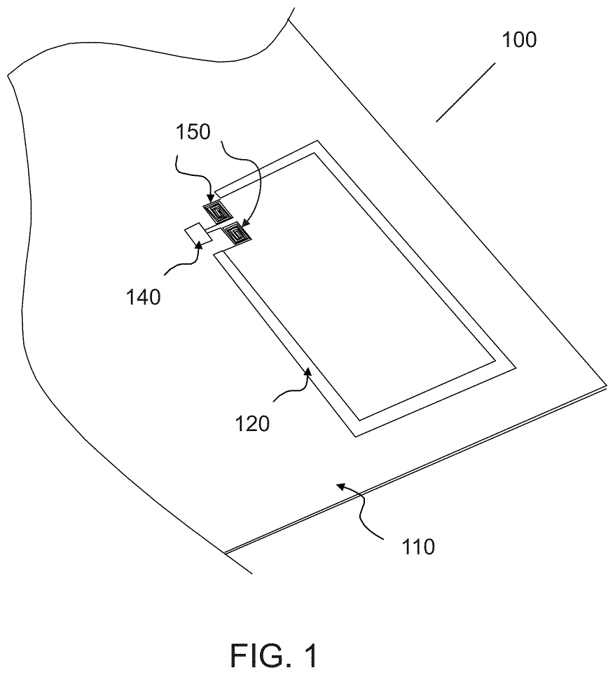

FIG. 1 illustrates a schematic representation of an antenna assembly 100. In an embodiment, the antenna assembly 100 includes a support 110, which may be, for example, a circuit board, a flexible circuit board or a thin film, or foil. The support 110 may be made of various materials, such as plastic, and it may even be wholly or partially transparent. Depending on the application, the support 110 may be flexible or rigid. It may also have a flat surface. On the support 110, one or more conductive layers are formed so that at least one antenna radiator 120 is patterned therein. Patterns in the conductive layers may be made by etching, printing, selective plating, sputtering or other manufacturing processes. The conductive layers may be made of metal such as copper, gold, silver or other materials, such as indium tin oxide. The antenna assembly further includes a conductive pad 140 for functioning as a feeding point for the antenna. The conductive pad 140 may be patterned in the one or more conductive layers and therefore fabricated in the same process as the rest of the conducting circuitry. It may, alternatively, be fabricated using other methods or even separately from the rest of the conducting circuitry. The conductive pad 140 is electrically coupled to the antenna radiator 120 to enable signal transfer between them. In an embodiment, the antenna assembly 100 additionally includes one or more antenna matching components 150 patterned in the conductive layer. Such antenna matching components 150 are integrated in the antenna pattern 120 so that they may be fabricated concurrently in the same process. Consequently, the conductive circuitry on the support 110 includes the at least one patterned antenna radiator 120, at least one conductive pad 110 and, optionally, one or more patterned antenna matching components 150. The conductive circuitry may be made thin, for example having thickness less than 300 μm, which enables arranging components close to each other in two or three dimensions. The compact size of the circuitry may also improve its bending properties, which can become important when flexible supports are used. In order to ground one or more of the antenna radiators 120, a ground plane may also be fabricated on the support 110 (not pictured).

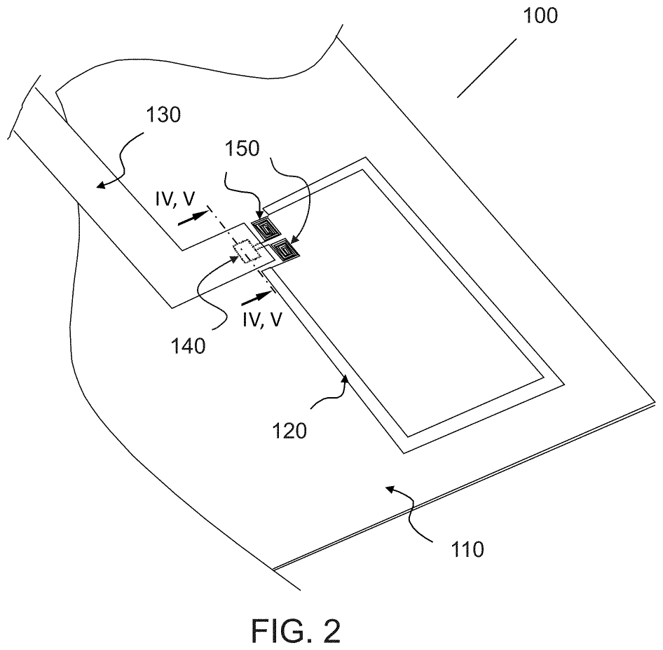

FIG. 2 illustrates another schematic representation of an antenna assembly 100. The antenna assembly 100 includes the features described above and, additionally, an RF transmission line structure 130 for transferring signals to and/or from the antenna radiator. The RF transmission line structure 130 is an external feed line which is attached to the support 110 and it may have characteristic impedance, for example, between 40 and 60 ohms or about 50 ohms. This allows first fabricating the circuitry on the support 110 and then selectively attaching one or more transmission lines according to an exemplary embodiment. The RF transmission line structure 130 may be of any shape, as illustrated in the figure by a bend. The RF transmission line 130 is either directly or indirectly attached to the support 110 so that it forms a capacitive coupling with a conductive pad 140. This allows for the connection itself to function as a capacitive antenna matching component. As an example, the capacitive coupling may be formed between two equally dimensioned capacitor plates, one in the RF transmission line 130 and one in the conductive pad 130, in which case the capacitance (C) between the RF transmission line 130 and the conductive pad 140 may be estimated by the formula:

$$C = \frac{ɛ S}{d}$$

where S is the surface area of the capacitor plates facing each other, d is the distance between the capacitor plates and ε is the dielectric constant of the material between the capacitor plates. Depending on the embodiment, the details of the coupling arrangement, such as the coupling geometry or materials, may be varied. For example, one or more layers of dielectric material may be used to fully or partially fill the space between the conducting elements, or the space may be left empty. The capacitive connection may also be made across the support 110, in which case a conductive pad 140 is located on one side of the support 110 and the RF transmission line structure 130 is coupled to the conductive pad 140 from the other side of the support 110 so that the support 110 functions as a dielectric in between. In this case, additional dielectric layers or openings may be formed between the transmission line structure 130 and the conductive pad 140, as desired.

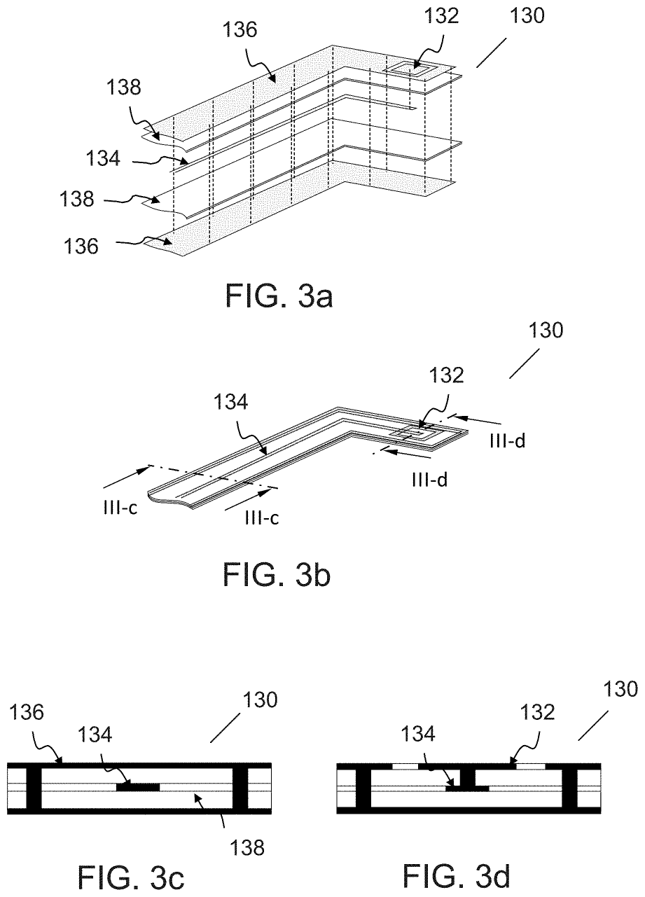

FIGS. 3a-d illustrate views of a schematic representation of an RF transmission line structure 130. In the figures, a coaxial transmission line is illustrated. However, the RF transmission line structure 130 may be constructed in other geometries and it may have other shapes. In an embodiment, the RF transmission line structure 130 includes a signal line 134 for transmitting the signal across the RF transmission line structure 130. In an embodiment, the signal line is connected to a conductive pad 132, which may be located at an end of the signal line 134. The conductive pad 132 provides an interface for coupling the transmission line 130 to the conductive pad 140 on the support 110. In the coaxial transmission line geometry, the RF transmission line includes a conductive sheath 136 surrounding dielectric material 138 further surrounding the signal line 134. A transmission line may be fabricated, for example, layer-by-layer as illustrated in FIGS. 3c-d where layers are separated by solid lines.

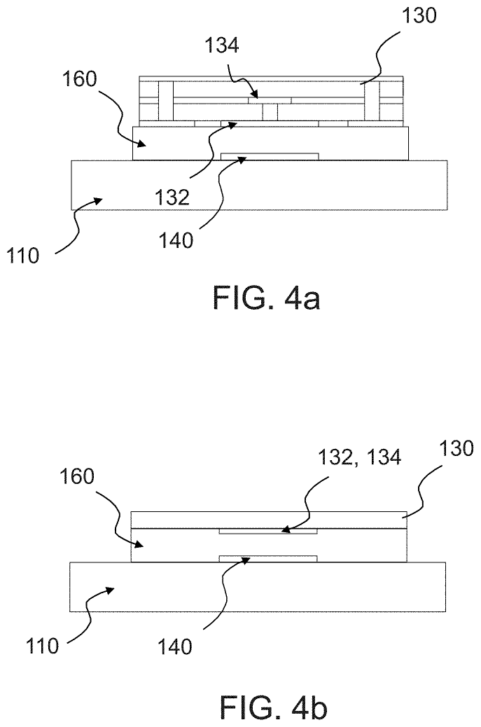

FIG. 4a illustrates a cross sectional view of a schematic representation of an RF transmission line structure 130 in an antenna assembly 100 at the position illustrated in FIG. 2. In the figure, a coaxial transmission line has been depicted, but the underlying concept may be extended to other transmission line geometries as well. The RF transmission line structure 130 is capacitively coupled to a conductive pad 140 on the support 110. The capacitive coupling is formed between a first conductive pad 140 on the support 110 and a second conductive pad 132 in the RF transmission line structure 130. In between, a layer of dielectric material 160 has been deposited. In an embodiment, the dielectric material is adhesive so that it may be used to attach the transmission line 130 to the support 110. While a conductive pad 132 for the transmission line 130 has been illustrated, it is possible also to couple the signal line 134 to conductive pad 140 on the support 110 without this additional structure. The conductive pad 132 allows, for example, the area of conducting interface capacitively coupling to the other conductive pad 140 to be extended in direction transverse to the signal line 134.

FIG. 4b illustrates a cross sectional view of a schematic representation of another RF transmission line structure 130 in an antenna assembly 100 at the position illustrated in FIG. 2. In the figure, a planar transmission line has been depicted but the underlying concept may be extended to other transmission line geometries as well. The RF transmission line structure 130 is capacitively coupled to a conductive pad 140 on the support 110. The capacitive coupling is formed between a first conductive pad 140 on the support 110 and the RF transmission line structure 130, where the coupling interface may be formed directly by the signal line 134 or by an additional conductive pad 132. The conductive pad 132 allows, for example, the area of conducting interface capacitively coupling to the other conductive pad 140 to be extended in direction transverse to the signal line 134. In between, a layer of dielectric material 160 has been deposited. In an embodiment, the dielectric material is adhesive so that it may be used to attach the transmission line 130 to the support 110.

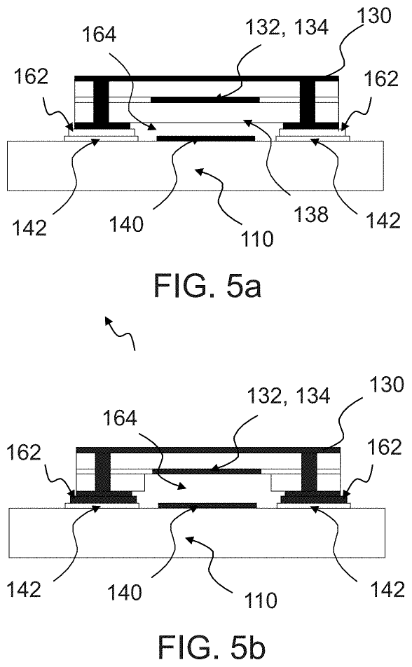

FIGS. 5a-b illustrate cross sectional views of schematic representations of RF transmission line structures 130 in an antenna assembly 100 at the position illustrated in FIG. 2. In the figure, a coaxial transmission line has been depicted but the underlying concept may be extended to other transmission line geometries as well. The RF transmission line structure 130 is capacitively coupled to a conductive pad 140 on the support 110. The capacitive coupling is formed between a first conductive pad 140 on the support 110 and the RF transmission line structure 130, where the coupling interface may be formed directly by the signal line 134 or by an additional conductive pad 132. The conductive pad 132 allows, for example, the area of conducting interface capacitively coupling to the other conductive pad 140 to be extended in direction transverse to the signal line 134. In between is a dielectric gap which may be formed by the dielectric material 138 being part of the RF transmission line structure 130 and an opening 164, which may be filled with air and have the corresponding dielectric properties, as in FIG. 5a. By preserving the dielectric sheath of the transmission line as part of the capacitive coupling and/or by creating the dielectric coupling across an opening, in the production process materials, costs and time may be saved. The dielectric gap may also be formed by an opening 164 extending all the way between the coupling interface 132, 134 of the RF transmission line structure 130 and the conductive pad 140, so that the opening 164 may be filled with air and have the corresponding dielectric properties, as in FIG. 5b. The RF transmission line structure 130 may be attached to the support 110 directly but the support may also include pads 142, for example of metal, for attaching the transmission line. In an embodiment, the RF transmission line structure 130 is attached to the support 110 with conductive adhesive or solder 162 and when the support includes one or more conductive, for example metallic, pads 142 for attachment, this connection may be used, for example, for grounding the RF transmission line structure 130. When conductive adhesive is used for attachment, heating of the support 110 may be further reduced to avoid damage.

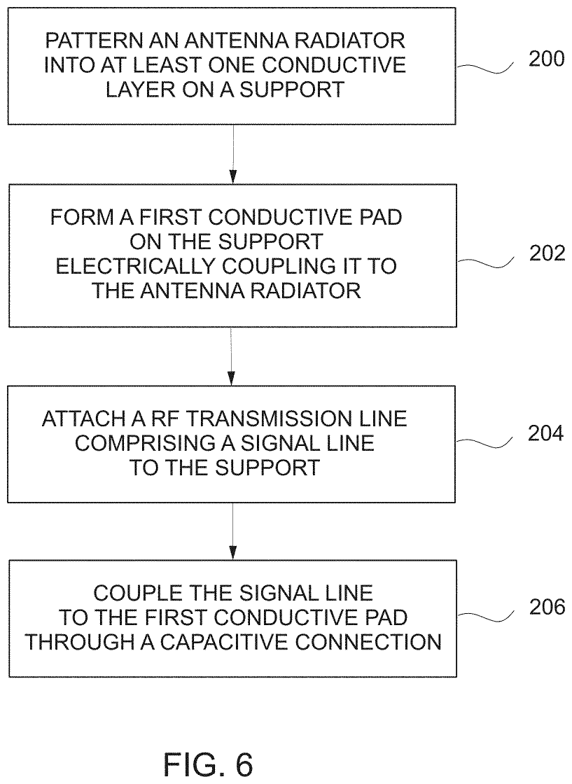

FIG. 6 illustrates a flowchart showing a method of forming an antenna assembly 100. In an embodiment, in 200 an antenna radiator 120 is patterned into at least one conductive layer on a support 110. In 202, a first conductive pad 140 is formed on the support 110 so that the conductive pad 140 is electrically coupled to the antenna radiator 120. In 204, an RF transmission line structure 130 including a signal line 134 is attached to the support 110. In 206, the signal line 134 is coupled to the first conductive pad 140 through a capacitive connection.

In an embodiment, an RF transmission line structure 130 is a printed circuit board. The transmission line may be constructed on a substrate, such as FR-4 glass-reinforced epoxy, or another composite material. The PCB techniques may be used to adapt the transmission line to the specific needs of the application. In a further embodiment, the RF transmission line structure 130 is a flexible printed circuit board so that it may be used in dynamic applications or to improve the packing of the antenna assembly 100.

In an embodiment, an RF transmission line structure 130 is a coaxial or a planar transmission line, both of which may be fabricated using PCB technology. For example, a planar transmission line may be constructed in various geometries such as a strip line, a microstrip or a coplanar waveguide. Consequently, the signal transfer properties of the transmission line may be adjusted to the application.

In an embodiment, the support 110 can be formed of dielectric material. The support may be plastic, such as polyimide or polyethylene terephthalate (PET). The support can also be glass, ceramic, composites or any other dielectric material. The support may be fabricated as a foil so that the thickness of the assembly may be reduced or so that the support becomes transparent.

In an embodiment, an RF transmission line structure 130 is attached to the support 110 with adhesive. The adhesive may be, for example, glue, adhesive paste or adhesive tape. It may also be electrically conductive adhesive. The adhesive may form a layer of dielectric material for capacitively coupling the RF transmission line structure to a conductive pad 140 on the support 110.

In an embodiment, the antenna assembly 100 includes one or more antenna matching components 150 patterned in at least one conductive layer and integrated to the antenna radiator 120. The components may include any number of components, such as resistive components, capacitive components and inductive components. This allows adjusting the frequency dependent impedance of the matching circuit, which further includes the capacitive coupling of the RF transmission line structure 130 to the support 110. The antenna matching components 150 may be patterned in the conductive layer in the same way and, optionally, in the same process as the antenna radiator 120 so that they become integrated with the antenna pattern. It is possible to include antenna matching components 150 along any part of the circuit composed of the antenna matching components 150 and the antenna radiator 120. As an example, all the antenna matching components 150 corresponding to a single antenna radiator 120 may be located between a first conductive pad 140 and the antenna radiator 120. Alternatively, some of them may be distributed along a conductive pattern including one or more antenna radiators 120. In both cases, the patterns form a monolithic electrical circuit so that the antenna radiators and the antenna matching components establish an integrated pattern. The integrated pattern may be of substantially constant height, for example of 100 μm or less.

In an embodiment, an apparatus includes at least one antenna assembly 100. The apparatus may be any apparatus utilizing wireless communication, such as a mobile telephone, a cellular telephone, a computer tablet, a phablet or a laptop with wireless capability. The apparatus may be, for example, portable, pocket-storable, hand-held, computer-comprised or vehicle-mounted mobile device. The apparatus may also be a wearable device, for example a device that may be worn by the user, such as a wrist-mounted device, a head-mounted device or an ankle-mounted device. In these devices, flexibility of materials may be desired.

Any range or device value given herein may be extended or altered without losing the effect sought. Also any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are provided as examples of implementing the embodiments and other equivalent features and acts are intended to be within the scope of the embodiments.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The steps of the methods described herein may be carried out in any suitable order, or simultaneously, where appropriate. Additionally, individual blocks may be deleted from any of the methods without departing from the spirit and scope of the subject matter described herein. Aspects of any of the embodiments described above may be combined with embodiments of any of the other embodiments described to form further embodiments without losing the effect sought.

The embodiments described herein are merely exemplary and any method, blocks or elements identified do not form an exclusive list and a method or apparatus may contain additional blocks or elements.

It will be understood that the above description is given by way of example only and that various modifications may be made by those of ordinary skill in the art. The above description, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. An antenna assembly comprising:
a support;
at least one conductive layer on the support having an antenna radiator patterned therein;
a first conductive pad on the support, the first conductive pad being electrically coupled to the antenna radiator; and
a radio frequency (RF) transmission line structure attached to the support, the RF transmission line structure comprising a signal line for transmitting an RF signal to or from the antenna radiator;
wherein the signal line is capacitively coupled to the first conductive pad.

2. The antenna assembly of claim 1, wherein the RF transmission line structure is a printed circuit board.

3. The antenna assembly of claim 2, wherein the RF transmission line structure is a flexible printed circuit board.

4. The antenna assembly of claim 1, wherein the RF transmission line structure is one of a coaxial or a planar transmission line.

5. The antenna assembly of claim 1, wherein the support is formed of dielectric material.

6. The antenna assembly of claim 1, wherein the RF transmission line structure is attached to the support with adhesive and the adhesive forms a layer of dielectric material through which the signal line is capacitively coupled to the first conductive pad.

7. The antenna assembly of claim 1, wherein the RF transmission line structure is attached to the support with one of conductive adhesive or solder.

8. The antenna assembly of claim 1 further comprising one or more antenna matching components patterned in the at least one conductive layer and integrated to the antenna radiator.

9. The antenna assembly of claim 8, wherein the one or more antenna matching components comprise one or more of resistive, capacitive and inductive components.

10. The antenna assembly of claim 9, wherein the antenna matching components have thickness of 100 μm or less.

11. The antenna assembly of claim 1, wherein the RF transmission line structure comprises a second conductive pad connected to an end of the signal line; the second conductive pad being suitable for capacitively coupling the signal line to the first conductive pad.

12. A method of forming an antenna assembly, comprising:
patterning an antenna radiator into at least one conductive layer on a support;
forming a first conductive pad on the support and electrically coupling the first conductive pad to the antenna radiator;
attaching a radio frequency transmission line structure comprising a signal line to the support; and
coupling the signal line to the first conductive pad through a capacitive connection.

13. The method of claim 12, wherein the RF transmission line structure is a printed circuit board.

14. The method of claim 13, wherein the RF transmission line structure is a flexible printed circuit board.

15. The method of claim 12 further comprising: attaching the RF transmission line structure to the support with adhesive and the adhesive forms a layer of dielectric material through which the signal line is capacitively coupled to the first conductive pad.

16. The method of claim 12 further comprising: attaching the RF transmission line structure to the support with one of conductive adhesive or solder.

17. The method of claim 12 further comprising: patterning one or more antenna matching components in the at least one conductive layer; wherein the antenna matching components are integrated to the antenna radiator.

18. The method of claim 12 further comprising: forming a second conductive pad for capacitively coupling the signal line to the first conductive pad; and connecting the second conductive pad to an end of the signal line in the RF transmission line structure.

19. An apparatus comprising an antenna assembly; the antenna assembly comprising:
a support;
at least one conductive layer on the support having an antenna radiator patterned therein;
a first conductive pad on the support, the first conductive pad being electrically coupled to the antenna radiator; and
a radio frequency (RF) transmission line structure attached to the support, the RF transmission line structure comprising a signal line for transmitting an RF signal to or from the antenna radiator;
wherein the signal line is capacitively coupled to the first conductive pad.

20. The apparatus of claim 19, wherein the apparatus is a mobile phone or a component of a mobile phone.
